(19) United States
(12) Patent Application Publication
(10) Pub. No.: US 2012/0223555 A1
(43) Pub. Date: Sep. 6, 2012

(54) Catbird seat apparatus

(76) Inventor: Robert Brown, JR., Warner Robins, GA (US)

(21) Appl. No.: 12/932,700

(22) Filed: Mar. 4, 2011

(51) Int. Cl. A47C 7/72; G01G 9/00; F16H 21/54

(52) U.S. Cl. 297/217.4; 74/96; 177/1

(57) ABSTRACT

A catbird seat means is an elevated advantaged overview position. The catbird seat apparatus includes an illuminated platform, therapeutic massaging vibrating command chair, with a multi-telecommunications device combination. A command chair means is a sitting instrument with therapeutic massaging vibrating motors, and a multi-telecommunications device combination means is a mixed or the same combination 3D-tv, document or image composer monitor, video phone monitor, computer monitor, multi-disc DVD monitor, satellite radio, video game monitor, digital photo monitor, or any audio or video thin control panel device for simultaneous entertainment, business, and educational use, mental and physical stimulation, or command sitting comfort with a method of supporting, viewing, controlling, or commanding a multi-telecommunications device combination within the 5 feet radius with arms extended, in the referenced catbird seat position.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### TECHNICAL FIELD

This invention relates generally to a catbird seat apparatus, and in particular to an illuminated platform with colorful lights, centered and mounted with a command chair with embedded seat sensors that activate a therapeutic massage and vibrate, while a left side and right side actuator device extend close and power up an attached maximum of three on the left side and three on the right side high definition telecommunications devices having a mixed or the same 3D-tv, document or image composer monitor, video phone monitor, computer monitor, multi-disc DVD monitor, satellite radio, video game monitor, digital photo monitor, or any audio or video thin control panel device measuring no more than 11″ L×8″ D×1″ H simultaneously while playing a user programmed motivating theme song or music, chime, or pre-recorded message.

### BACKGROUND OF THE INVENTION

Command chair innovations and global telecommunications device trends have enhanced today's lifestyles with entertainment comfort. The current major problem encountered by the user is that the final product designs are lacking in intrinsic value, lacking personality with a flare of excitement, and are therapeutically needy, tiring, and boring for sitting short periods or long work hour days. The world's leading consumer electronics producer once controlled the pulse, now U.S. relinquishes manufacturing and yet the demand for products labeled Made In U.S. remains high. Getting on pace with responding to these claims; responding to the current U.S. economic development challenges increasing employment rates and stimulating jobs growth; responding to the message and efforts of U.S. President Obama urging tax cuts, business innovators and owners to stimulate the economy creating jobs; developing new product enhancement initiatives for a disabled military war veteran quality of life and lifestyle; and stimulating returning war veterans re-employment opportunities with Brown Systems, Inc. new startup manufacturing operations, assembly, and production plants construction initiatives initially within the U.S., a dual-use catbird seat apparatus assembled with an illuminated platform, centered, mounted with a therapeutic massaging vibrating command chair with a high definition multi-telecommunications device combination is invented.

The catbird seat apparatus has a user fee service for video phone, internet, video game, satellite radio, DVD movies, and television programming estimated cost $30-$50 per month. The intended user is any leader or manager, disabled person especially disabled technology savvy military war veterans, teacher, child, teen, or adult at home, library, business, classroom, laboratory, vacation resort, or video game arcade.

### BRIEF SUMMARY OF THE INVENTION

A primary objective of the present invention is to provide a dual-use catbird seat apparatus, comprising a colorful lighted illuminated platform, mounted and centered with a command chair with embedded seat sensors that anytime a user weighing more than 20 pounds sits down activates the fabric and leather cushion therapeutic massaging and vibrating, activates the left side and right side actuator device connected to the embedded extending attachment arm support connected to the telescoping attachment arm support extending close, that attaches the left side and right side high definition multi-telecommunications device combination having a mixed or the same 3D-tv, document or image composer monitor, video phone monitor, computer monitor, multi-disc DVD monitor, satellite radio, video game monitor, digital photo monitor, or any audio or video thin control panel device powering up simultaneously while playing a user programmed motivating theme music, chimes, or pre-recorded message. Selecting and pressing the armrest power off button or remote control device power off button for a specific monitor or completely powering all functions off to exit the catbird seat activates the embedded extending attachment arm support connected to the telescoping attachment arm support extending open, simultaneously the high definition multi-telecommunications device combination power off while playing the user programmed motivating theme music, chime, or pre-recorded message. Adjustable armrest controls allow children with shorter arms functional reach with fingertip controls access.

The characteristic of the present invention is that any audio or video thin control panel device measuring up to 11″ L×8″ D×1″ H can be attached; the frame is made of aluminum, plastic, or wood; and the actuator device connected to the embedded extending attachment arm support connected to the telescoping attachment arm support, connected to the flex swivel joints attaches the multi-telecommunications device combination, that also can be adapted for a disabled person, and especially for a skilled technology savvy military war veteran powered wheelchair.

### BRIEF DESCRIPTION OF THE DRAWINGS

FIG. 1 is a perspective view of the preferred embodiment of the present catbird seat apparatus.

FIG. 2 is a rear view of the preferred embodiment of the present catbird seat apparatus.

FIG. 3-3A is a side view of the preferred embodiment of the catbird seat apparatus.

FIG. 4-4A is a top down views of the preferred embodiment of the catbird seat apparatus.

FIG. 5-5C is an armrest view of the preferred embodiment of the catbird seat apparatus.

FIG. 6-6B is an actuator device, embedded extending attachment arm support, telescoping attachment arm support, with a multi-telecommunications device combination assembly view of the preferred embodiment of the catbird seat apparatus.

FIG. 7-7G is an accessory equipment view of the preferred embodiment of the catbird seat apparatus.

### DETAILED DESCRIPTION OF THE INVENTION

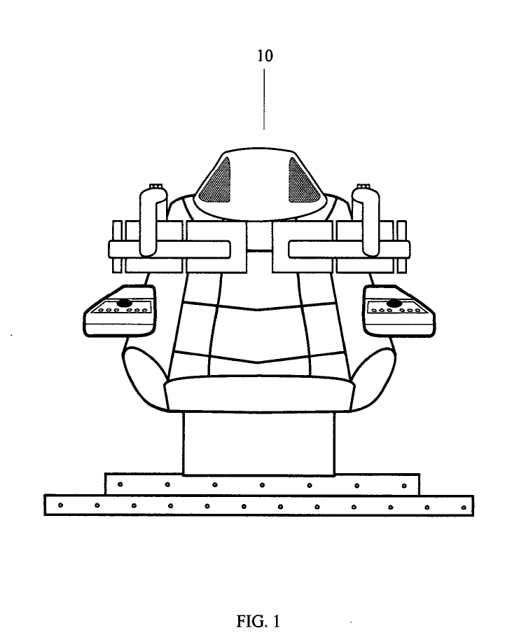

Referring now to the drawings, it is to be understood that the invention is not limited to the exact construction of method illustrated and described below, but that various changes and modifications may be made without departing from the spirit and scope of the invention as set forth in the following description, and particularly to FIGS. 1-7, a preferred embodiment of the catbird seat apparatus assembled with an illuminated platform, centered and mounted with a therapeutic massaging vibrating command chair with a high definition multi-telecommunications device combination of the present invention is shown and generally designated by the reference numeral 10.

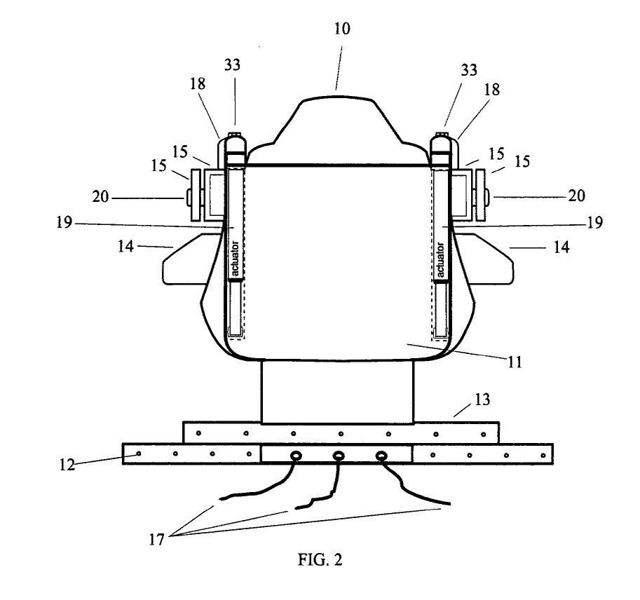

In FIG. 1, the perspective view of a catbird seat apparatus 10 of the present invention for entertainment, business and educational use simultaneously, mental and physical stimulation, and command sitting comfort with a method of supporting, viewing, controlling, and commanding a multi-telecommunications device combination within a 5 feet radius, with arms extended. Anytime a user sits down weighing 20 pounds or more in the seat power up the multi-telecommunications device combination, actuator device adjust attachment arm supports in front of user view while playing user theme song or music, chime, or pre-recorded message. Anytime a user need to exit user press the remote control device extend open button, adjustable armrest manual control extend open button, or breakaway actuator devices. The greater detail is illustrated and will be described FIG. 2-7 as follows:

In FIG. 2, the rear view of a catbird seat apparatus 10 is illustrated and will be described. More particularly, the catbird seat apparatus 10 has electricity wire, cable wire, and a phone wire 17 disposed within the illuminated platform 13 space with colorful lights 12. The illuminated platform 13 is centered and mounted with the therapeutic massaging vibrating command chair 11 with the actuator device 19 connected to the embedded extending attachment arm support 18 secured by the nut 33, attaches the telescoping attachment arm support 20 to the multi-telecommunications device combination 15 having a mixed or the same 3D-tv, document or image composer monitor, video phone monitor, computer monitor, multi-disc DVD monitor, satellite radio, video game monitor, digital photo monitor, or any audio or video thin control panel device measuring up to 11″ L×8″ D×1″ H, with accenting armrest 14.

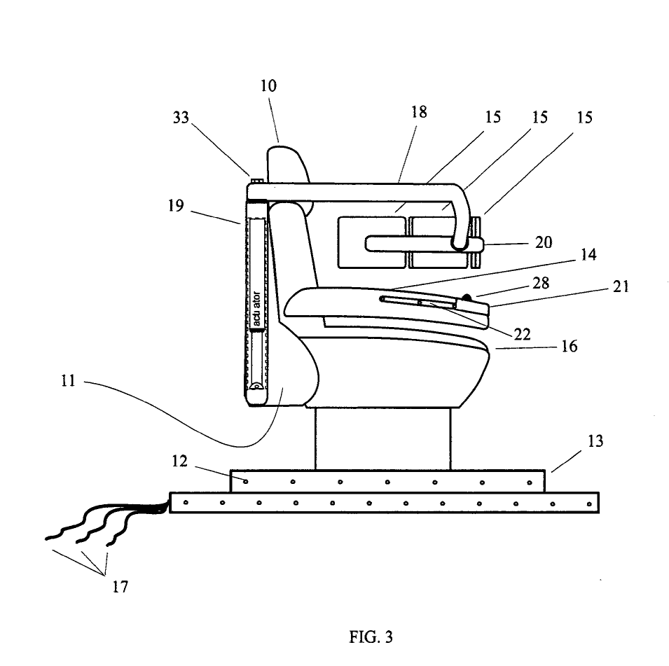

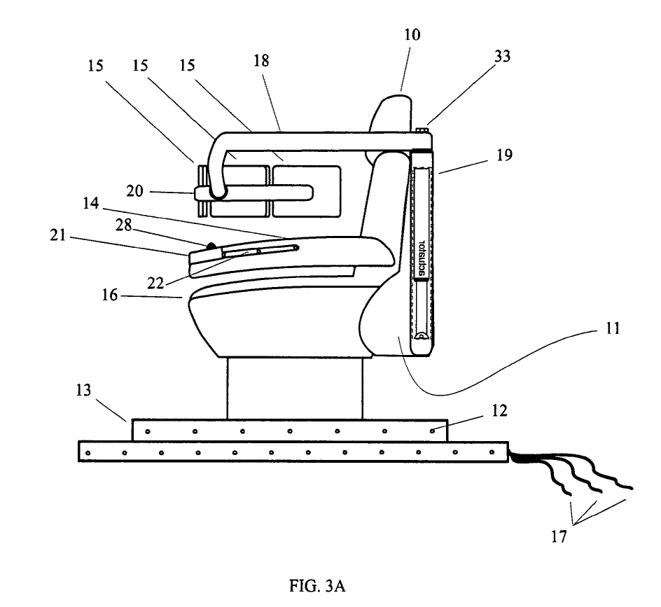

In FIG. 3-3A, the mirror image left side or right side view of a catbird seat apparatus 10 is illustrated and will be described. More particularly, the catbird seat apparatus 10 has the colorful lights 12, electricity wire, cable wire, and phone wire 17 disposed within the illuminated platform 13 space. The illuminated platform 13 is centered and mounted with the therapeutic massaging vibrating command chair 11 connected to the actuator device 19 connected to the embedded extending attachment arm support 18 secured with the nut 33, connected to the telescoping attachment arm support 20 attaches the multi-telecommunications device combination 15 having a mixed or same combination 3D-tv, document or image composer monitor, video phone monitor, computer monitor, multi-disc DVD monitor, satellite radio, video game monitor, digital photo monitor, or any audio or video thin control panel device measuring up to 11″ L×8″ D×1″ H. The cushioned fabric and leather upholstery command chair seat 16 is accented with armrest 14, having an adjustable armrest manual button controls platform 21 with navigation mouse ball 28, with track insert 22.

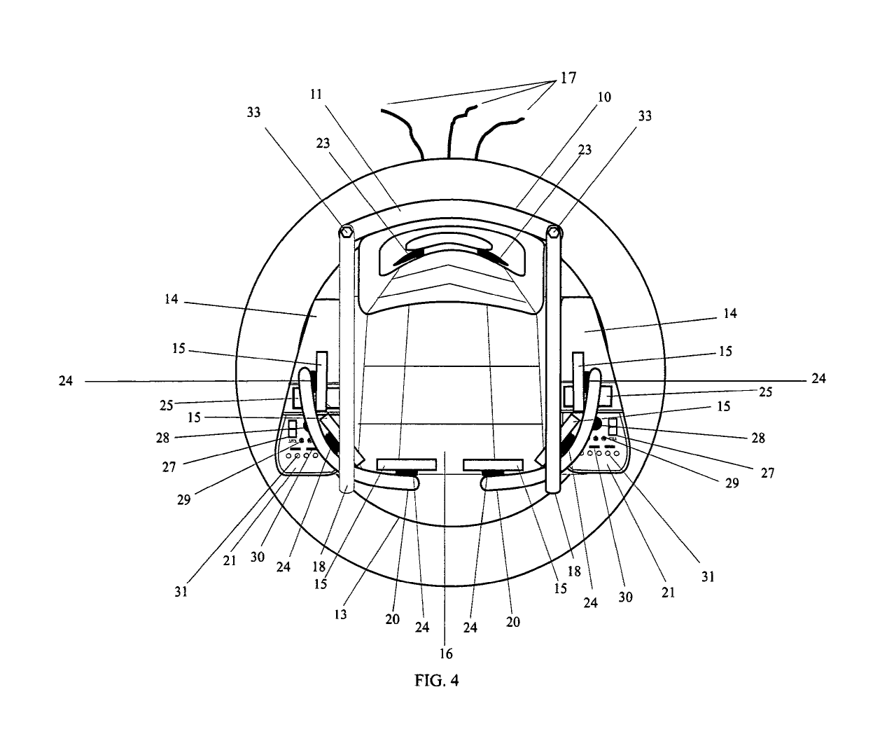

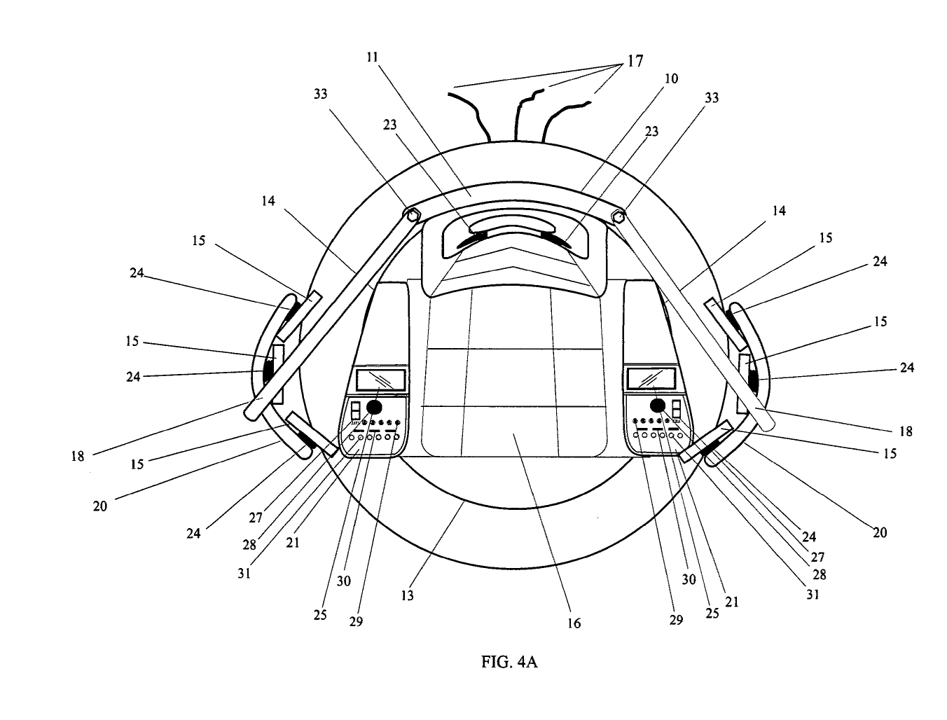

In FIG. 4, the embedded extending attachment arm support extended close top down view of a catbird seat apparatus 10 is illustrated and will be described. More particularly, the catbird seat apparatus 10 centered and mounted with a massaging vibrating command chair 11 having an embedded weight sensor seat 16 on an illuminated platform 13 space, with the headrest surround sound speakers 23, and electricity wire, cable wire, and phone wire 17 disposed within an illuminated platform 13 space. The nut 33 secures the embedded extending attachment arm support 18 connected to the telescoping attachment arm support 20 attaches to the flex swivel joints 24 attaching the multi-telecommunications device combination 15 having a mixed or same combination 3D-tv, document or image composer monitor, video phone monitor, computer monitor, multi-disc DVD monitor, satellite radio, video game monitor, digital photo monitor, or any audio or video thin control panel device measuring up to 11″ L×8″ D×1″ H. The left side and right side armrest 14 has the adjustable armrest manual button controls platform 21 having a touch screen remote controls 25, chair tilt controls 27, navigation mouse ball 28, accessory jack ports 29, USB ports 30, with manual control buttons 31.

In FIG. 4A, the embedded extending attachment arm support pivoted open top down view of a catbird seat apparatus 10 is illustrated and will be described. More particularly, the catbird seat apparatus 10 centered and mounted with a massaging vibrating command chair 11 having an embedded weight sensor seat 16 on an illuminated platform 13 space, with the headrest surround sound speakers 23, and electricity wire, cable wire, and phone wire 17 disposed within an illuminated platform 13 space. The nut 33 secures the embedded extending attachment arm support 18 connected to the telescoping attachment arm support 20 attaches flex swivel joints 24 attaching a multi-telecommunications device combination 15 with a mixed or same combination 3D-tv, document or image composer monitor, video phone monitor, computer monitor, multi-disc DVD monitor, satellite radio, video game monitor, digital photo monitor, or any audio or video thin control panel device measuring up to 11″ L×8″ D×1″ H. The left side and the right side armrest 14 has the adjustable armrest manual button controls platform 21 with the accessory equipment as a touch screen remote controls 25, chair tilt controls 27, navigation mouse ball 28, accessory jack ports 29, USB ports 30, with manual control buttons 31.

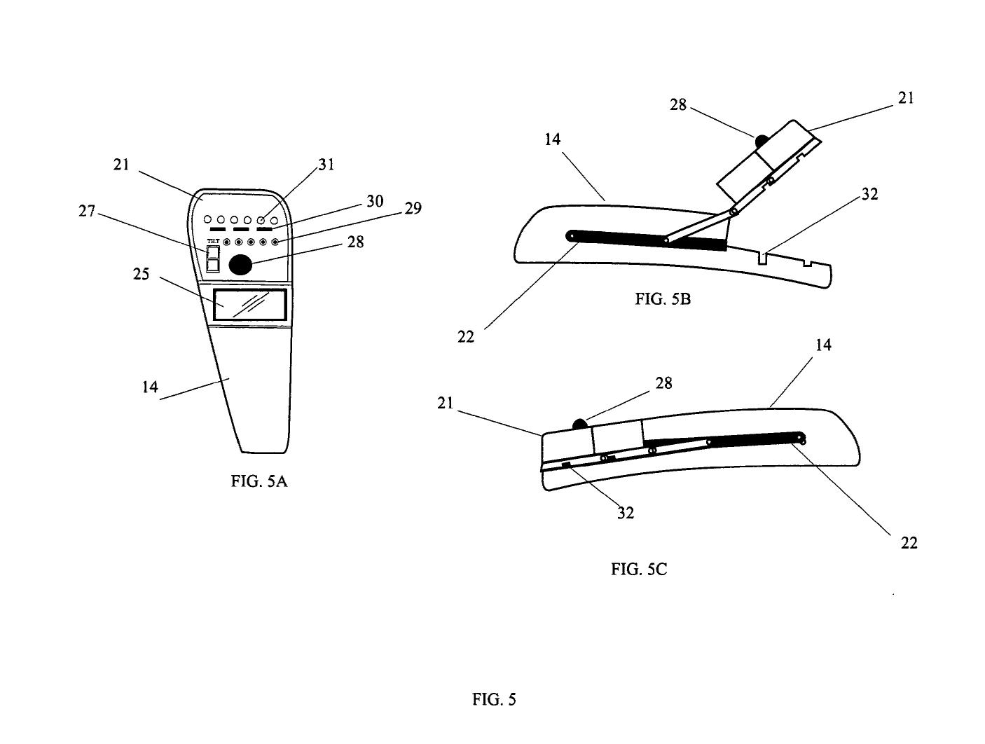

In FIG. 5, the armrest 14 view of a catbird seat apparatus 10 is illustrated and will be described. More particularly, the FIG. 5A view of a catbird seat apparatus 10 has the armrest 14 comprising an adjustable armrest manual button controls platform 21, touch screen remote controls 25, chair tilt controls 27, navigation mouse ball 28, accessory jack ports 29, USB ports 30, with manual control buttons 31; and FIG. 5B and FIG. 5C view the armrest 14 comprising the adjustable armrest manual button controls platform 21, mounted with a navigation mouse ball 28, on a platform track insert 22, with wireless keyboard insert grooves 32.

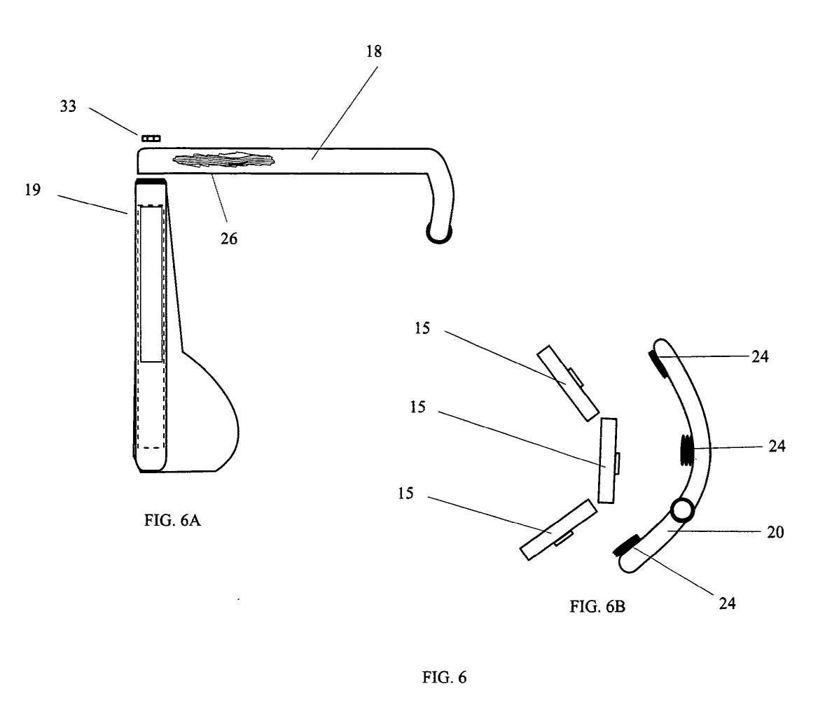

In FIG. 6, the actuator device 19, embedded extending attachment arm support 18, with telescoping attachment arm support 20 breakdown view of a catbird seat apparatus 10 is illustrated and will be described. More particularly, the FIG. 6A view the actuator device 19 connects to the embedded extending attachment arm support 18, secured with nut 33, with connecting multi-telecommunications device combination wiring 26 inside attachment arm support walls. The FIG. 6B view the telescoping attachment arm support 20 attaches the flex swivel joints 24 which attaches to the high definition multi-telecommunications device combination 15 having a mixed or same combination 3D-tv, document or image composer monitor, video phone monitor, computer monitor, multi-disc DVD monitor, satellite radio, video game monitor, digital photo monitor, or any audio or video thin control panel device measuring up to 11″ L×8″ D×1″ H is illustrated of the preferred embodiment of the catbird seat apparatus 10.

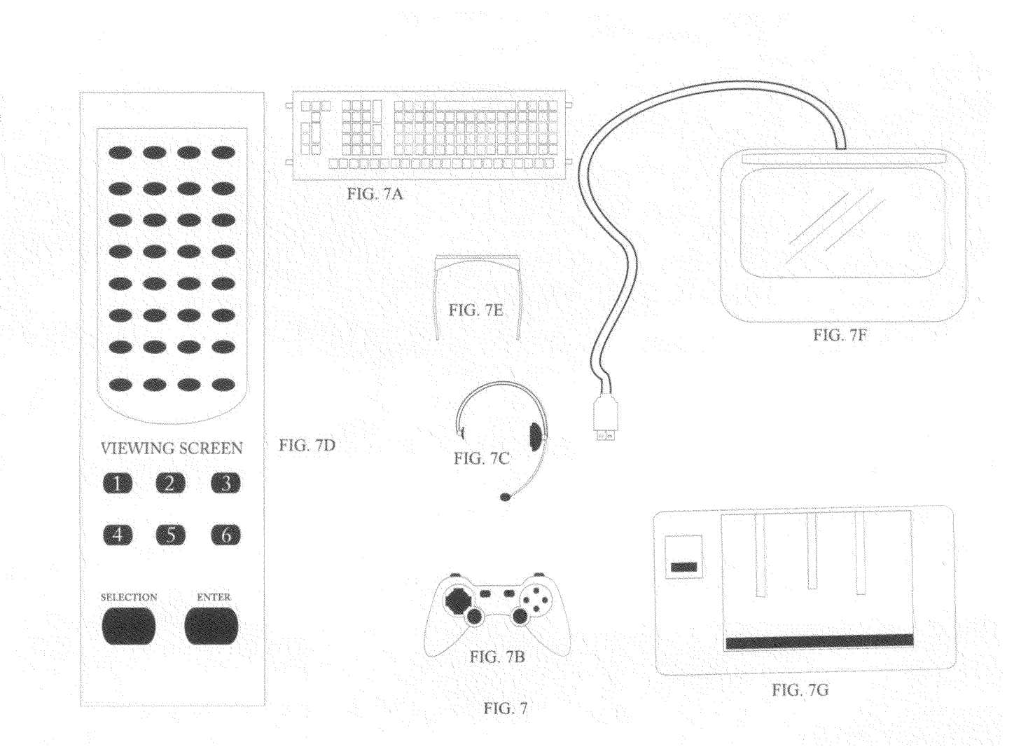

In FIG. 7, the accessory equipment view of a catbird seat apparatus 10 is illustrated and will be described. More particularly, the FIG. 7A wireless keyboard view, FIG. 7B video game joystick view, FIG. 7C Bluetooth headphone view, FIG. 7D remote control device view, FIG. 7 E 3D glasses view, FIG. 7F digital drawing tablet view, with FIG. 7G wireless printer view of the preferred embodiment of the catbird seat apparatus 10.

I claim:

1. A catbird seat apparatus, comprising:
an illuminated step-up platform centered and mounted with a therapeutic massaging vibrating command chair;
a colorful illuminated step-up aluminum or wood platform;
an actuator device;
a left side and right side actuator device connected to the therapeutic massaging vibrating command chair left side and right side;
a left side breakaway embedded extending attachment arm support connected to the left side actuator device;
a left side telescoping attachment arm support connected to the pivoting breakaway embedded extending attachment arm support left side;
a right side breakaway embedded extending attachment arm support connected to the right side actuator device;
a left side telescoping attachment arm support connected to the breakaway embedded extending attachment arm support right side;
a flex swivel joints connected to the left side and right side telescoping attachment arm support;
a left side and right side high definition multi-telecommunications device combination connected to the left side and right side telescoping attachment arm support attached flex swivel joints; and
a remote control device, adjustable armrest manual button controls, armrest navigation mouse ball, armrest manual button controls platform, wireless keyboard, wireless printer, wireless blue tooth headphone, power on/off switch, satellite radio controls, tilt controls, video game joystick, 3D glasses, remote control device, and Portable Media Player and USB ports as accessory equipment.

2. The catbird seat apparatus of claim 1, wherein the user entertainment, business, or educational simultaneous use, mental and physical stimulation, and command sitting comfort with a method of supporting, viewing, controlling, and commanding a multi-telecommunications device combination within the 5 feet radius with arms extended.

3. The catbird seat apparatus of claim 1, wherein the frame is aluminum or wood.

4. A method for functional activation of a catbird seat apparatus, comprising:
a seat weight sensor;
a fabric or leather cushion upholstery;
a 20 pounds minimum weight limit activation embedded sensor;
a massaging vibrating motors; and
a massaging vibrating motors <= or >12VAC 1000 mA@2 W.

5. The catbird seat apparatus of claim 4, wherein the 20 pounds minimum weight limit activation means is a user must weigh 20 pounds or more sitting in the seat.

6. The catbird seat apparatus of claim 4, further comprising a user anytime sitting down activates therapeutic massaging and vibrating.

7. The catbird seat apparatus of claim 4, further comprising a user anytime sitting down activates user programmed or downloaded theme music, chime, or pre-recorded message playing.

8. The catbird seat apparatus of claim 4, further comprising a user anytime sitting down activates embedded extending attachment arm support extending close.

9. The catbird seat apparatus of claim 4, further comprising a user anytime sitting down activates left side and right side high definition multi-telecommunications device combination powering up.

10. The catbird seat apparatus of claim 1, wherein the left side and right side high definition multi-telecommunications device combination means is having a telecommunications device maximum of three on the left side and three on the right side mixed or same 3D-tv, document or image composer monitor, video phone monitor, computer monitor, multi-disc DVD monitor, satellite radio, video game monitor, digital photo monitor, or any audio or video thin control panel device measuring up to 11″ L×8″ D×1″ H.

11. A method for extending close or extending open embedded extending attachment arm support of a catbird seat apparatus, comprising:
a pivoting actuator device;
a left side and right side pivoting actuator device; and
a left side and right side breakaway pivoting actuator device.

12. The catbird seat apparatus of claim 1, wherein the catbird seat means an elevated advantaged overview position.
